(19) United States
(12) Patent Application Publication
(10) Pub. No.: US 2005/0068164 A1
(43) Pub. Date: Mar. 31, 2005

(54) Alarm arrangement

(76) Inventor: Jan Hjalmarsson, Broby (SE)

Correspondence Address: HARNESS, DICKEY & PIERCE, P.L.C., P.O. BOX 8910, RESTON, VA, 20195, US

(21) Appl. No.: 10/488,785

(22) PCT Filed: Sep. 5, 2002
(86) PCT No.: PCT/SE02/01581

(30) Foreign Application Priority Data
Sep. 6, 2001 (SE) 0102947-9

(51) Int. Cl. G08B 29/00

(52) U.S. Cl. 340/506; 340/531

(57) ABSTRACT

A connecting unit for alarm purposes includes a power supply device for supplying power to at least one acoustic alarm unit, a measuring device for measuring the energy consumption of the alarm unit, and a calling device for calling a predetermined first telephone number if the measured energy consumption indicates that an acoustic alarm is emitted by the at least one alarm unit.

### FIELD OF THE INVENTION

The invention relates to a connecting unit for alarm purposes according to the preamble to claim 1.

### BACKGROUND ART

Acoustic, battery-powered alarm units are currently used to a very great extent in dwellings and other premises. Such an alarm unit comprises a detector for detecting a certain state, for instance a smoke detector for detecting smoke emission. By acoustic is meant that it further comprises a sound unit for emitting a sound signal in the case where the above state is detected. The sound signal is intended to wake up and/or warn people in the premises where the alarm unit is installed. The sound unit and the detector unit are powered by means of a battery in the alarm unit.

Alarm units of the above type are usually in the form of alarm units for detecting smoke emission. Such alarm units are mass-produced and thus inexpensive. They are also very reliable and save many lives every year.

However, investigations have demonstrated that many installed alarm units of the above type are not in operation since they do not have a working battery. This gives a false feeling of security and can be a consequence of the battery of the alarm unit being “lent” for some other purpose, after which it has not been reinserted. It may also be a consequence of the battery of the alarm unit being discharged and not being replaced by a new battery. Alarm units in the form of smoke/fire detectors are often mounted in the ceiling, which makes an exchange of battery difficult.

### SUMMARY OF THE INVENTION

An object of the present invention is to wholly or partly eliminate the above problems.

This object is achieved by a connecting unit for alarm purposes, which has the features stated in claim 1. More specifically, the invention thus relates to a connecting unit for alarm purposes, which is characterised by a power supply means for supplying power to at least one acoustic alarm unit, a measuring means for measuring the energy consumption of the alarm unit, and a calling means for calling a predetermined first telephone number if the energy consumption measured by said measuring means indicates that an acoustic alarm is emitted by the alarm unit;
Such a connecting unit can cooperate with an acoustic alarm unit of the above type. Since the connecting unit is used to supply power to the alarm unit, no battery is required in the alarm unit. Therefore the risk of the alarm unit not being in working order is smaller. Furthermore an emitted alarm can be effective even if no one is staying in the premises and can hear it. This is due to the fact that a predetermined telephone number, belonging to a given telephone subscriber, is called. The subscriber can be, for example, an emergency service centre or a security company, which can take the requisite measures.

The calling means is preferably adapted to make a call a predetermined period of time after indication of an alarm. This makes it possible for the user to switch off the alarm unit in case of false alarm, before calling takes place.

According to a preferred embodiment, the connecting unit is adapted to make a call via a stationary telecommunication network and is then preferably arranged to be supplied with power from this telecommunication network. As a result, the connecting unit can be made very simple and cheap.

Alternatively, the connecting unit may comprise a battery unit or a mains supply unit.

The connecting unit preferably comprises a first operating means, the activation of which results in calling a second predetermined telephone number This makes it possible for the user to check the functioning of the connecting unit

The connecting unit is preferably adapted to break the connection with the first telephone number after a predetermined period of time. This makes it possible, for instance, for a security company to make a return call to the premises from which the alarm is emitted in order to verify that the alarm is not false.

According to a further preferred embodiment, the connecting unit may comprise a second operating means, in which case activation of the second operating means results in breaking the power supply to the alarm unit for a period of time of a predetermined length. This makes it possible for the user to temporarily switch off the alarm unit if a false alarm can be expected, for instance in connection with cooking.

Preferably, the power supply means comprises a contact means corresponding to that of a standard battery. As a result, the connecting unit can be easily made to cooperate with largely all acoustic, battery-powered alarm units.

### BRIEF DESCRIPTION OF THE DRAWING

FIG. 1 shows schematically the construction of a connecting unit according to an embodiment of the invention. The connecting unit is connected to an acoustic alarm unit

### DESCRIPTION OF PREFERRED EMBODIMENTS

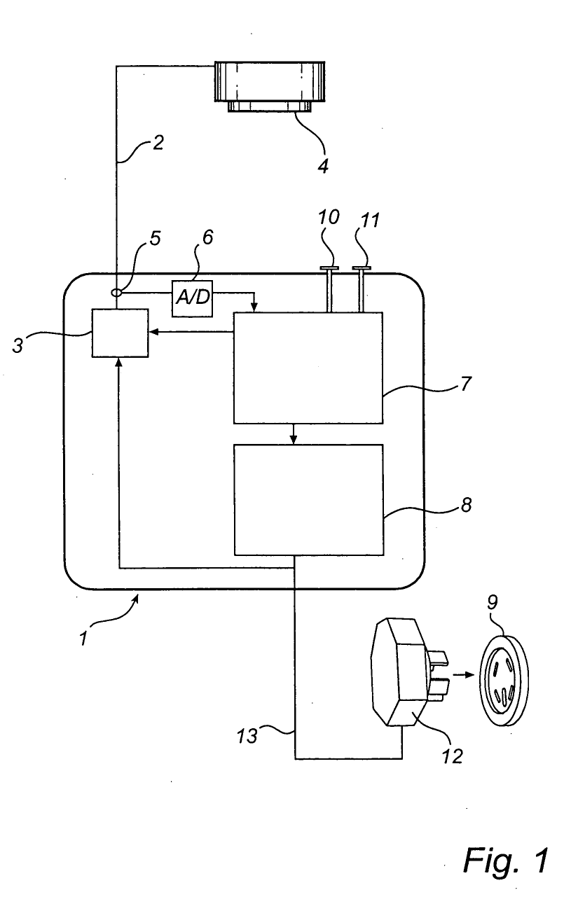

FIG. 1 illustrates schematically the construction of a connecting unit 1 according to an embodiment of the invention. The connecting unit 1 is connected by means of a cord 2 to an acoustic alarm unit 4. The alarm unit 4 can preferably be a smoke detector. The connecting unit 1 comprises a power supply means 3 which by means of the cord 2 supplies power to the alarm unit 4. Since alarm units of this type are usually arranged to be fitted with a 9V battery, the cord 2 can be a 2-conductor cord with the simplest type of insulation. At the end remote from the connecting unit 1, the cord 2 is preferably provided with a contact means (not shown), which corresponds to that of a 9V standard battery and can thus be easily connected to the battery contact of the alarm unit 4. The power supply means 3 can in turn obtain power from the stationary telecommunication network if the connecting unit 1 is connected to this network as will be described below. If this is not possible or permissible, a mains supply unit or an internal battery (not shown) can be used. If a battery is used, it must of course be exchanged at intervals. However, the connecting unit 1 need not be mounted in the ceiling, and therefore an exchange of battery can be carried out fairly easily.

The connecting unit 1 further comprises a power transducer 5 which measures the energy consumption of the alarm unit a. The power transducer 5 can be designed as a current sensor which measures the current consumption at a given voltage. Alternatively, the terminal voltage of the power supply means 3, and thus the voltage drop across the alarm unit 4, can be measured. Other methods for measuring the energy consumption of a device are known to those skilled in the art. The connecting unit 1 also comprises an A/D converter 6 which converts the measured power or energy consumption of the alarm unit 4 into a digital value which is supplied to a control unit 7. The control unit 7 may consist of a microprocessor (CPU). In that case, the A/D converter is necessary since a CPU usually requires digital input signals The control unit 7 can monitor the energy consumption of the alarm unit 4. If an alarm is emitted by the alarm unit 4, its energy consumption rises drastically since an emitted sound signal requires a relatively great amount of power. The control unit 7 can thus detect an emitted alarm, for instance by detecting that the power consumption exceeds a threshold value, and then, preferably after a predetermined period of time of some ten seconds or some tenths of seconds, initiate calling of a predetermined first telephone number belonging to a subscriber.

The control unit 7 then emits a sigal to a calling unit 8, which via, for instance, a stationary telecommunication network calls said first predetermined subscriber. To this end, the connecting unit 1 comprises a telephone cord 13 and a plug 12 which is intended to be connected to a telephone jack 9. If possible, the power supply means 3 can then receive its power from the telephone jack 9 by means of the cord.

In environments where a stationary telecommunication network is not available or cannot be used, a variant of the connecting emit 1, provided with an integrated mobile phone, can be used. In such a variant, power supply by means of a battery or a mains supply unit has to be used, as mentioned above.

When a predetermined subscriber has been called as stated above, he or she can establish, by means of a number display or the like, from where the call comes and thus from where the alarm has been emitted. Preferably, the connecting unit 1 then breaks the connection when a predetermined period of time has passed. The called subscriber, which for instance can be a security company or an emergency service centre, can then call back to check whether the alarm is false.

The connecting unit 1 comprises a first operating means 10, such as a button. If this is activated (pressed), the control unit 7 makes the calling unit 8 call another predetermined telephone number. In this way the user can check the function of the connecting unit 1 without emitting an alarm. If a correct call takes place, this can be confirmed by means of an indicator light (not shown) on the connecting unit 1. Alternatively, the user can check, by means of a telephone using the same line as the connecting unit 1, that this line is occupied (no dialling tone is given).

The connecting unit 1 also comprises a second operating means 11. Also this operating means 11 has the shape of a button When the second operating means 11 is activated, the control unit 7 makes the power supply means 3 break the power supply to the alarm unit 4 for a period or time of a predetermined length. This can be used, for instance, in cooking involving a smell of smoke when the user knows that there is risk of false alarm. When the period of time has expired, the alarm unit 4 is again supplied with power.

The connecting unit 1 may further comprise a calibrating means. For instance, a third operating means (not shown) can be activated when the alarm unit 4 is connected, but does not sound The control unit can then collect and store information about the normal energy consumption of the alarm unit 4. This makes it possible to use the connecting unit 1 with alarm units of many different types and makes.

The invention is not restricted to the embodiments described above, and may be varied within the scope of the appended claims. For example, the acoustic alarm unit can be of a type other than a smoke detector, such as a burglar alarm unit, a leakage alarm unit etc., depending on which detector is included in the alarm unit. Also several alarm units of the same type or different types can be connected in parallel to the connecting unit, which are monitored individually. Different telephone numbers can then be called depending on which alarm unit emits an alarm. Alternatively, a signal indicating the type or types of alarm can be emitted to the subscriber called.

As appreciated by those skilled in the art, the different modules 3, 5, 6, 7, 8 included in the connecting unit may be configured in various ways. In FIG. 1, they are shown, for the sake of clarity, as separate modules for power supply, control, calling etc. However, it is possible to integrate several of these modules with each other, for instance in the form of an ASIC (ASIC=Application Specific Integrated Circuit). Alternatively, the modules shown can be realised in terms of software, such as program code, which is suited to be executed in a microprocessor.

1. A connecting unit for alarm purposes, comprising:
power supply means for supplying power to an acoustic alarm unit;
measuring means for measuring the energy consumption of the alarm unit; and
calling means for calling a predetermined first telephone number if the energy consumption measured by said measuring means indicates that an acoustic alarm is emitted by the alarm unit.

2. A connecting unit as claimed in claim 1, wherein the calling means is adapted to make a telephone call a predetermined period of time after indication of an alarm.

3. A connecting unit as claimed in claim 1, wherein the calling means is adapted to make a telephone call via a stationary telecommunication network.

4. A connecting unit as claimed in claim 3, wherein the connecting unit is arranged to be supplied with power from said telecommunication network.

5. A connecting unit as claimed in claims 1, further comprising a battery unit.

6. A connecting unit as claimed in claims 1, further comprising a mains supply unit.

7. A connecting unit as claimed in claim 1, further comprising a first operating device which, when activated, results in the calling of a second predetermined telephone number.

8. A connecting unit as claimed in claims 1, wherein the connecting unit is adapted to break the connection with said first telephone number after a predetermined period of time.

9. A connecting unit as claimed in claim 7, further comprising a second operating device which, when activated, results in breaking of power supplied to the alarm unit for a period of time of a predetermined length.

10. A connecting unit as claimed e claim 1, wherein the power supply means includes a contact device corresponding to that of a standard battery.

11. A connecting unit as claimed in claim 2, wherein the calling means is adapted to make a telephone call via a stationary telecommunication network.

12. A connecting unit as claimed in claim 2, further comprising a battery unit.

13. A connecting unit as claimed in claim 2, further comprising a mains supply unit.

14. A connecting unit as claimed in claim 3, further comprising a battery unit.

15. A connecting unit as claimed in claim 3, further comprising a mains supply unit.

16. A connecting unit as claimed in claim 2, further comprising a first operating device which, when activated, results in the calling of a second predetermined telephone number.

17. A connecting unit as claimed in claim 2, wherein the connecting unit is adapted to break the connection with said first telephone number after a predetermined period of time.

18. A connecting unit as claimed in claim 1, further comprising an operating device which, when activated, results in breaking of power supplied to the alarm unit for a period of time of a predetermined length.

19. A connecting unit as claimed in claim 2, further comprising an operating device which, when activated, results in breaking of power supplied to the alarm unit for a period of time of a predetermined length.

20. A connecting unit for alarm purposes, comprising:
a power supply unit, adapted to supply power to at least one acoustic alarm unit;
a measuring device, adapted to measure energy consumption of the at least one alarm unit; and
a calling device, adapted to call a predetermined first telephone number if the energy consumption measured by the measuring device indicates that an acoustic alarm is emitted by the at least one alarm unit.
